(19) United States
(12) Patent Application Publication
(10) Pub. No.: US 2011/0289499 A1
(43) Pub. Date: Nov. 24, 2011

(54) TECHNIQUES TO AUTOMATICALLY UPDATE SOFTWARE APPLICATIONS

(75) Inventors: Jeremy Haubold, Portage, IN (US); Scott McCulloch, Kirkland, WA (US)

(73) Assignee: MICROSOFT CORPORATION, Redmond, WA (US)

(21) Appl. No.: 12/783,161

(22) Filed: May 19, 2010

(51) Int. Cl. G06F 9/44

(52) U.S. Cl. 717/173

(57) ABSTRACT

Techniques to automatically update software applications are described. An apparatus may comprise a processor and a memory. The memory may store an update component that when executed by the processor is operative to manage updates for an application program. The update component may comprise an update manager and a permission manager. The update manager may be operative to update a file version for one or more application files of the application program and store one or more current file version identifiers for the one or more application files of the application program in the memory. The permission manager may be operative to receive a communication request to communicate with a remote device from the application program prior to communicating information to the remote device, and send a communication response granting or denying the communication request to the application program based on the one or more current file version identifiers. Other embodiments are described and claimed.

### BACKGROUND

Software applications typically need periodic updates. The software updates may be for new product features, security enhancement, or other improvements. As a number of software applications implemented for a given computer increases, the complexity of updating each of the software applications increases as well. Further, many software applications are part of a suite of applications, thereby making updates to one software application conditional upon other software applications within the same suite. Other problems arise with software updates, such as balancing trade-offs between urgency of software updates against disruptions to user access to a given software application or a device implementing a software application. For example, software updates for security features may be prioritized over the inconvenience of forced reboots, while software updates for ancillary product features may be installed at the convenience of a user. Given the number of design considerations for software updates, enhanced software update techniques providing increased control and flexibility over the software update process become increasingly important. It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

In one embodiment, an apparatus may comprise a processor and a memory. The memory may store an update component that when executed by the processor is operative to manage updates for an application program. The update component may comprise an update manager and a permission manager. The update manager may be operative to update a file version for one or more application files of the application program and store one or more current file version identifiers for the one or more application files of the application program in the memory. The permission manager may be operative to receive a communication request to communicate with a remote device from the application program prior to communicating information to the remote device, and send a communication response granting or denying the communication request to the application program based on the one or more current file version identifiers. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a software update architecture.

FIG. 2 illustrates an embodiment of a first logic flow.

FIG. 3 illustrates an embodiment of a first operating environment.

FIG. 4 illustrates an embodiment of a second operating environment.

FIG. 5 illustrates an embodiment of a third operating environment.

FIG. 6 illustrates an embodiment of a second logic flow.

FIG. 7 illustrates an embodiment of a fourth operating environment.

FIG. 8 illustrates an embodiment of a computing architecture.

### DETAILED DESCRIPTION

Various embodiments are generally directed to techniques to automatically update software applications. Some embodiments are particularly directed to automatically retrieving update packages for software applications and installing update files for software applications at a client device prior to using the software applications for their intended purpose, such as communicating with a remote device, such as a server. This may save time and resources when a remote device requires a particular version of a software application prior to establishing a communication session. For instance, when a client device contacts a server having incompatible versions of a software application, processing and communications resources are wasted by the client device, server and network. Ensuring version compatibility prior to attempting to establish a communication session reduces such wasted resources. As a result of these and other advantages, the embodiments can improve affordability, scalability, modularity, extendibility, or interoperability for an operator, device or network.

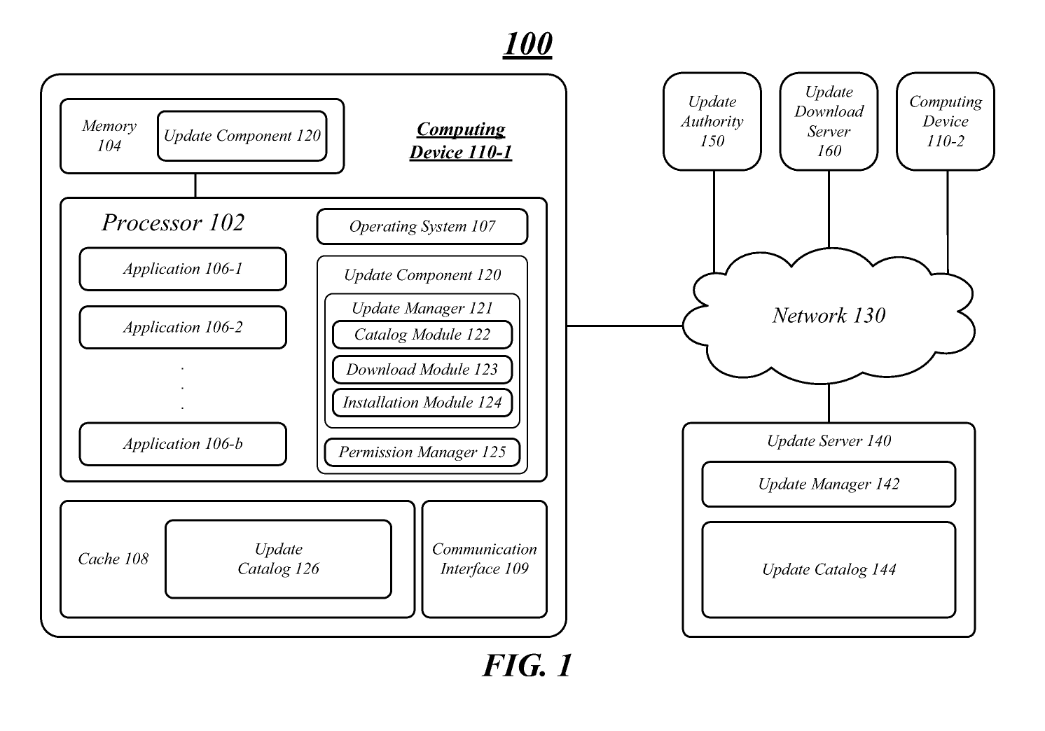

FIG. 1 illustrates a block diagram for a software update architecture 100 suitable for implementing one or more enhanced software update techniques to effectively and efficiently allow electronic systems and devices to utilize applications and communicate information using known and compatible versions of software applications.

In various embodiments, the software update architecture 100 may comprise a computer-implemented software update architecture 100 having multiple types of systems and devices composed of multiple hardware and software components. As used herein the terms “system” and “component” and “module” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In various embodiments, the software update architecture 100 may be implemented as a distributed system that distributes portions of the structure and/or operations for the media sharing techniques across multiple computing entities. Examples of a distributed system may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In the illustrated embodiment shown in FIG. 1, all or some of the software update architecture 100 may be implemented as part of one or more electronic devices having both computing and communications capabilities. The communications capabilities may include both wired and wireless communications capabilities. Examples of an electronic device may include without limitation a computing device, a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. The embodiments are not limited in this context.

The various systems and devices shown as part of the software update architecture 100 may be communicatively coupled via various types of communications media, such as a wired and/or wireless network. Similarly, components for a given system or device may coordinate operations between each other. The coordination may involve the uni-directional or bi-directional exchange of information. For instance, certain components may communicate information in the form of signals communicated over a communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In the illustrated embodiment shown in FIG. 1, the software update architecture 100 may comprise multiple computing devices 110-1-a, an update server 140, an update authority 150, and an update download server 160, all communicating over a network 130. Although the software update architecture 100 as shown in FIG. 1 has a limited number of elements in a certain topology, it may be appreciated that the software update architecture 100 may include more or less elements in alternate topologies as desired for a given implementation.

The network 130 may comprise a communications framework designed to communicate information between the various devices of the software update architecture 100. The network 130 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators).

The update server 140 may comprise or employ one or more server computing devices and/or server programs that operate to perform various methodologies in accordance with the described embodiments. For example, when installed and/or deployed, a server program may support one or more server roles of the server computing device for providing certain services and features. Exemplary update server 140 may include, for example, stand-alone and enterprise-class server computers operating a server OS such as a MICROSOFT® OS, a UNIX® OS, a LINUX® OS, or other suitable server-based OS. Exemplary server programs may include server programs for asset inventory, software distribution, software updates, and infrastructure security, such as a Microsoft Systems Management Server (SMS). Other exemplary server programs may include communications server programs such as Microsoft Office Communications Server (OCS) for managing incoming and outgoing messages, messaging server programs such as Microsoft® Exchange Server for providing unified messaging (UM) for e-mail, voicemail, VoIP, instant messaging (IM), group IM, enhanced presence, and audio-video conferencing, and/or other types of programs, applications, or services in accordance with the described embodiments.

The update authority 150 may also comprise or employ one or more server computing devices and/or server programs that operate to perform various methodologies in accordance with the described embodiments. For example, when installed and/or deployed, a server program may support one or more server roles of the server computing device for providing certain services and features. Exemplary update authority 150 may include, for example, stand-alone and enterprise-class server computers operating a server OS such as a MICROSOFT OS, a UNIX OS, a LINUX OS, or other suitable server-based OS. In one embodiment, for example, the update authority 150 may be a trusted software source, such as Microsoft Corporation, wherein the trusted software source maintains information concerning software updates.

The update server 140 may include an update manager 142 and an update catalog 144. The update manager 142 allows the update server 140 to obtain the update catalog 144 from the update authority 150. In one embodiment, the update catalog 144 may be configured as an extensible markup language (XML) document, and includes information about the availability of software updates (“patches”) and the version of the software to which they should be applied. Additionally, the update catalog 144 may include complex file update rules, typically in the form of Boolean logic, which prescribes the conditions under which individual software updates should be installed. For instance, the file update rules may implement business logic controlling installation of file updates for individual application programs or application programs that are part of a product suite. Therefore, the update manager 142 is configured to communicate with the update authority 150, to maintain the resident copy of the update catalog 144 in current form. Additionally, the update manager 142 is configured to check for a code, such as an “authenticode,” to determine if the update catalog 144 is authentic, or has been corrupted, tampered with or otherwise rendered useless or harmful.

The update download server 160 may also comprise or employ one or more server computing devices and/or server programs that operate to perform various methodologies in accordance with the described embodiments. For example, when installed and/or deployed, a server program may support one or more server roles of the server computing device for providing certain services and features. Exemplary update authority 150 may include, for example, stand-alone and enterprise-class server computers operating a server OS such as a MICROSOFT OS, a UNIX OS, a LINUX OS, or other suitable server-based OS. In one embodiment, for example, the update download server 160 stores officially certified updates for software applications, such as applications 106-1-b of the computing devices 110-1-a. Various devices of the software update architecture 100 may obtain updates for software applications stored by the update download server 160. Information on the location of the update download server 160 and/or a particular update package for a software application may be stored in the update catalog 144. For example, the update catalog 144 may include one or more uniform resource locators (URL) linking to a particular update package for a software application stored by the update download server 160. Updates obtained for a client may then be replicated to the client using SMS or other software distribution technology.

In one embodiment, a representative computing device 110-1 may be implemented as a client computing device, such as a handheld computer, laptop, personal computer, tablet, workstation, etc. The computing device 110-1 may have multiple application programs 106-1-b installed on the computing device 110-1. The application programs 106-1-b generally may allow a user to accomplish one or more specific tasks. In various implementations, the application programs 106-1-b may provide one or more graphical user interfaces (GUIs) to communicate information between the computing device 110-1 and a user. Examples of application programs 106-1-b may include, without limitation, messaging applications, web browsing applications, personal information management (PIM) applications (e.g., contacts, calendar, scheduling, tasks), word processing applications, spreadsheet applications, database applications, media applications (e.g., video player, audio player, multimedia player, digital camera, video camera, media management), gaming applications, and so forth. It is also to be appreciated that the computing device 110-1 may implement other types of applications in accordance with the described embodiments.

In one embodiment, the computing device 110-1 may include various system programs as well, such as operating system (OS) 107. System programs generally may assist in the running of the computing device 110-1 and may be directly responsible for controlling, integrating, and managing the individual hardware components of the computer system. The OS 107 may be implemented as any suitable OS consistent with the described embodiments, such as a Microsoft Windows OS, for example. The computing device 110-1 may comprise other system programs such as device drivers, programming tools, utility programs, software libraries, application programming interfaces (APIs), and so forth.

In one embodiment, a computing device 110-2 may be implemented as a server computing device. The computing device 110-2 may comprise or employ one or more server computing devices and/or server programs that operate to perform various methodologies in accordance with the described embodiments. For example, when installed and/or deployed, a server program may support one or more server roles of the server computing device for providing certain services and features. Exemplary computing device 110-2 may include, for example, stand-alone and enterprise-class server computers operating a server OS such as a MICROSOFT OS, a UNIX OS, a LINUX OS, or other suitable server-based OS. Exemplary server programs may include, for example, network storage server programs such as MICROSOFT® LIVE providing online network storage of documents and files, including multimedia or media files such as images, photographs, photo albums, videos, video albums, and so forth. Exemplary server programs may further include, for example, network application programs such as social networking application programs, search applications, document management programs, weblogs (blogs), word processing programs, spreadsheet programs, database programs, drawing programs, document sharing programs, message applications, web services, web applications, web server, and/or other types of programs, applications, or services in accordance with the described embodiments.

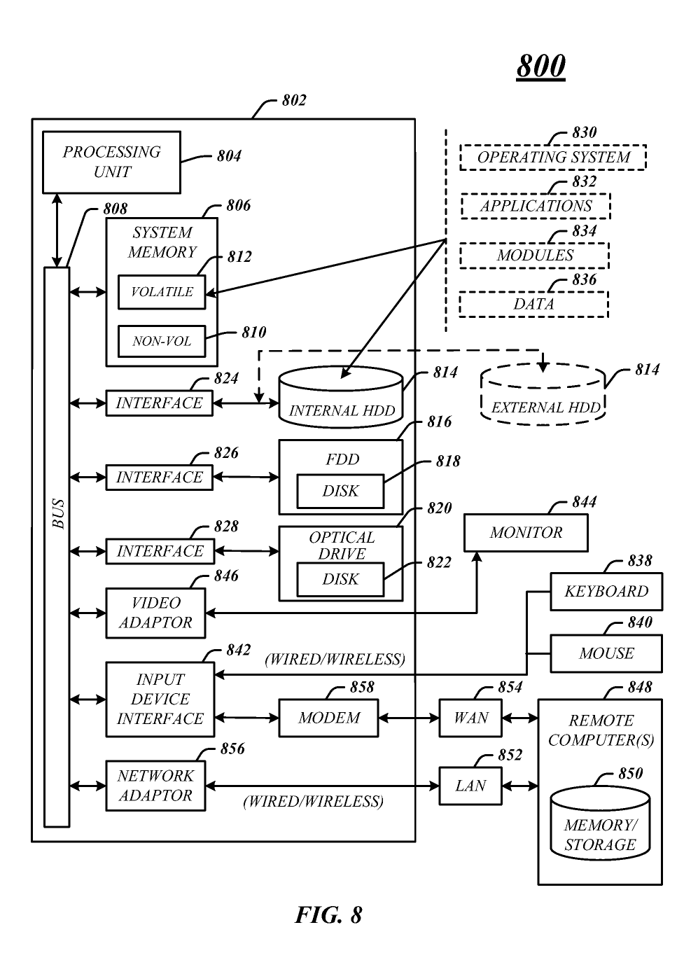

The computing devices 110-1-a, including the computing devices 110-1, 110-2 described above, may each comprise a processor 102 and a memory 104 communicatively coupled to the processor 102. The processor 102 and the memory 104 may each be communicatively coupled to a communication interface 109. An exemplary architecture and examples for computing devices 110-1-a may be described with reference to FIG. 8.

In various embodiments, the software update architecture 100 may implement enhanced software update and distribution techniques to update software applications installed on the various devices of the software update architecture 100, including the computing device 110-1. In conventional systems, software updates typically occur after an application program attempts to be used for its intended purpose, such as communicating with another application program implemented by another device. For instance, a client message application may attempt to initiate communications with a server message application only to find that its version of client message application is older than current versions acceptable for use by the server message application. When this occurs, the client message application may attempt to update its application files with updated versions using any number of conventional software update techniques. In the meantime, however, the client message application has consumed processing resources in generating a message and communications request, and communications resources by communicating the message and communications request over a network to a message server. Further, the message server has consumed processing resources in receiving the message and communications request and analyzing the communications request to determine it is in improper format used by an older version of software, as well as more communication resources in communicating a deny response and instructions to update the client message application before attempting another communication.

To solve these and other problems, the computing device 110-1 may include an update component 120 that when executed by the processor 102 is operative to manage updates for an application program 106-1-b. The update component 120 may implement enhanced software update techniques to ensure version compatibility prior to attempting to establish a communication session between devices to more efficiently use computing and communications resources. The update component 120 may also operate as an enforcement mechanism to ensure file updates are applied to the application programs 106-1-b before wasting any computing and/or communications resources due to version incompatibilities.

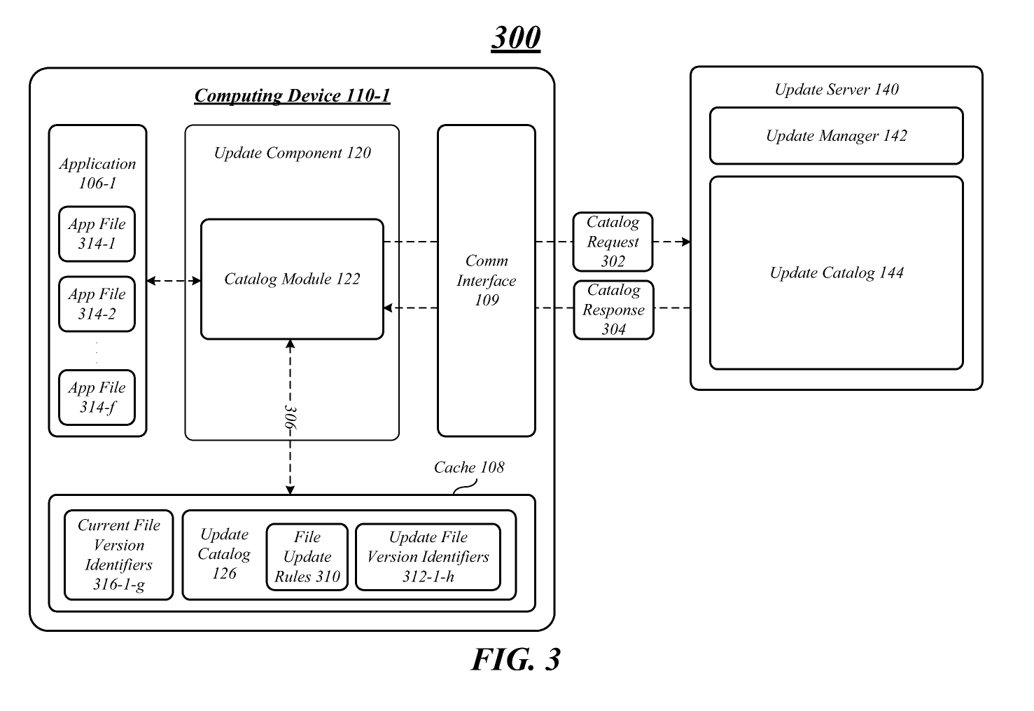

As shown in FIG. 1, the update component 120 may comprise an update manager 121 and a permission manager 125. The update manager 121 may further comprise a catalog module 122, a download module 123 and an installation module 124. The catalog module 122 may manage a client update catalog 126, and synchronize the client update catalog 126 with a server update catalog 144 stored by the update server 140, as discussed in more detail with reference to FIG. 3.

The update manager 121 may be generally arranged to coordinate and manage update operations for the computing device 110-1 with the other devices of the software update architecture 100. For instance, the update manager 121 may communicate with the update server 140 to coordinate updates for the computing device 110-1. In one embodiment, the update server 140 may coordinate with the update authority 150 and the update download server 160 to facilitate update operations for the update manager 121. In one embodiment, the update manager 121 of the computing device 110-1 may be arranged to directly interact with the update authority 150 and the update download server 160, thereby reducing or eliminating the need for the update server 140.

In one embodiment, the update manager 121may be operative to update a file version for one or more application files of the application programs 106-1-b, and store one or more current file version identifiers for the one or more application files of the application programs 106-1-b in the memory 104 and/or cache 108. Each application program 106-1-b may comprise one or more application files, either as source code, or more commonly, as executable code. Each of the application files may have a certain version associated with it. Software versioning is the process of assigning unique version identifiers to unique states of computer software. The unique version identifiers may comprise unique version names, unique version numbers, or combinations thereof. Version identifiers are generally assigned in increasing order and correspond to new developments in the software. Revision control is often used for keeping track of incrementally different versions of computer software and other electronic information. A variety of version identifying schemes may be implemented to keep track of different versions of an application program 106-1-b and/or its associated application files, and the embodiments are not limited to a particular type of versioning scheme.

In one embodiment, the update manager 121 may include various update tools, such as Windows Management Instrumentation, SMS client software, an XML parser, custom GUI views, and other elements typically used for software update operations. The client update catalog 126 provides information regarding the relationship between files potentially present on the computing device 110-1 and updates which may need to be installed on those files. The update manager 121 may read the update catalog 136, which is typically in the form of an XML document, using an XML parser. The update manager 121 may query the OS 107 to determine a precise revision level of programs and/or files present on the computing device 110-1. The update manager 121 may base each query in part on the outcome of previous queries and on the rules, typically expressed as Boolean equations, within the update catalog 126. Accordingly, the update manager 121 is arranged to determine a file type and revision level of all relevant files on the computing device 110-1, and additionally to determine the updates that are applicable to the files found. When completed, this information may be used during software update operations for the computing device 110-1.

The permission manager 125 may be generally arranged to implement various update enforcement techniques. Prior to operation, each of the various application programs 106-1-b may communicate with the update component 120 to ensure it is using a current version for the application program 106-1-b as defined by the client update catalog 126. The update component 120 allows application programs 106-1-b to query very quickly (e.g., less than 10 ms) whether or not an application program 106-1-b has any pending updates, and the urgency of those updates (e.g., required/optional). The update component 120 also allows application programs 106-1-b to query more slowly, or optionally, as needed. A fast query may be accomplished by reading an associated current file version identifier that is stored locally in the memory 104 and/or the cache 108. The current file version identifier may be set on a first run of an application program 106-1-b after the update component 120 initializes and executes as a background process/thread, and when fully instantiated does a full query of what updates are available for a given application program 106-1-b.

A full query may comprise, for example, communicating with the update server 140 for an update catalog having update information, and evaluating update rules within the update catalog to determine applicability of any pending updates. If the updates are applicable, their status (e.g., required/optional) is cached locally at the cache 108, and a background download of update packages may be initiated asynchronously. The download rate of update packages may be throttled to preserve bandwidth for the computing device 110-1. After all pending update packages are downloaded, a graphic user interface (GUI) view is presented to a user, informing them that certain software updates are available, and prompting them to install. When the update packages are unpacked and actually installed for one or more application programs 106-1-b, a success parameter may be used to evaluate whether update operations were successful or a failure condition has occurred. In case of a failure condition, a given update may be rolled back to a previous version of the application programs 106-1-b. When the update packages are unpacked and actually installed for multiple application programs 106-1-b within a product suite, a success parameter may be used to evaluate whether any of the update operations have failed for a given application program 106-1-b within the product suite. In the case of a single or multiple failures, all updates for a product suite may be rolled back in order to preserve a same version used throughout the product suite.

In one embodiment, the permission manager 125 may be operative to receive a communication request to communicate with a remote device, such as the computing device 110-2, from an application program 106-1-b prior to communicating information to the computing device 110-2. For instance, assume an application program 106-1 of the computing device 110-1 is a message application used for communicating messages via a message server application or web service implemented by the computing device 110-2. The permission manager 125 may send a communication response granting or denying the communication request to the application program 106-1-b based on the one or more current file version identifiers. By actively checking whether an application program 106-1-b of the computing device 110-1 has a software version compatible with software applications implemented by the computing device 110-2, computing and communications resources may be saved relative to those consumed by checking software version compatibility only after attempting to communicate with the computing device 110-2 via control and media signals communicated over the network 130.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

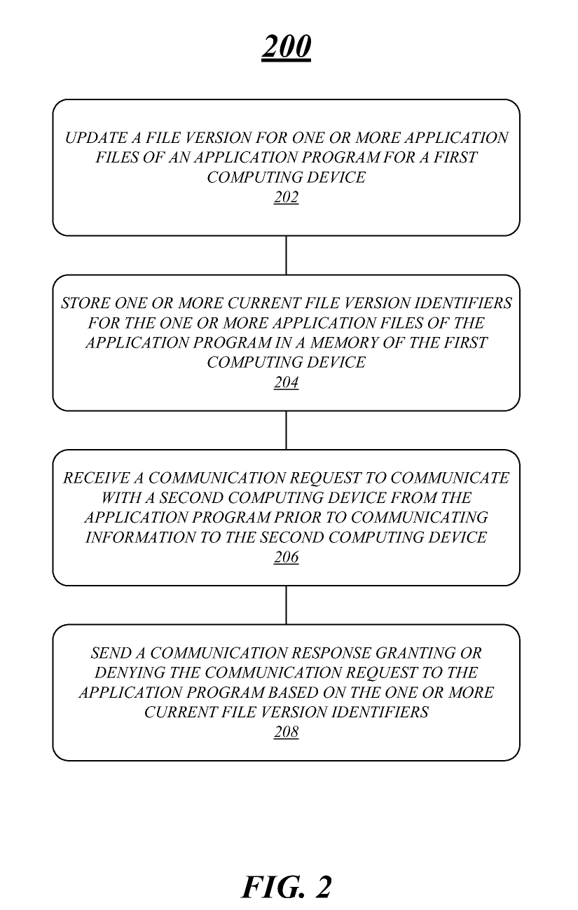

FIG. 2 illustrates one embodiment of a logic flow 200. The logic flow 200 may be representative of some or all of the operations executed by one or more embodiments described herein. For instance, the logic flow 200 may be representative of some or all of the operations executed by the computing device 110-1 and the update component 120.

In the illustrated embodiment shown in FIG. 2, the logic flow 200 may update a file version for one or more application files of an application program for a first computing device at block 202. For example, the update manager 121 may update a file version for one or more application files of an application program 106-1-b for the computing device 110-1.

The logic flow 200 may store one or more current file version identifiers for the one or more application files of the application program in a memory of the first computing device at block 204. For example, the update manager 121 may store one or more current file version identifiers for the one or more application files of the application programs 106-1-b in the memory 104 and/or the memory 108 of the computing device 110-1. The file version identifiers may be tracked using any desired versioning technique.

The logic flow 200 may receive a communication request to communicate with a second computing device from the application program prior to communicating information to the second computing device at block 206. For example, the permission manager 125 may receive a communication request to communicate with another computing device 110-2 from an application program 106-1-b prior to communicating information to the computing device 110-2.

The logic flow 200 may send a communication response granting or denying the communication request to the application program based on the one or more current file version identifiers at block 208. For example, the permission manager 125 may generate and send a communication response granting or denying the communication request to the requesting application program 106-1-b based on the one or more current file version identifiers.

FIG. 3 illustrates an embodiment of an operating environment 300 suitable for the software update architecture 100. The operating environment 300 illustrates signaling and/or message flow between the various devices of the software update architecture 100 to provide enhanced software update services for the representative computing device 110-1, for example. The computing device 110-1 may include the application program 106-1 and the update component 120. The application program 106-1 may be implemented as a message application such as Windows Messenger Client (WMC) or Windows Live Messenger (WLM), for example. However, the application program 106-1 may be implemented as other application programs as well.

In the illustrated embodiment shown in FIG. 3, the update manager 121 of the update component 120 may comprise a catalog module 122. The catalog module 122 may generally manage an update catalog used to store update information for the computing device 110-1. In one embodiment, the catalog module 122 may synchronize the client update catalogs 126 with the server update catalog 144. Each update catalog 126, 144 may include update information needed for update operations of the application programs 106-1-b of the computing device 110-1. In one embodiment, for example, the update catalogs 126, 144 may have a set of file update rules 310 and update file version identifiers 312-1-h for one or more application files 314-1-f of one or more application programs 106-1-b. The file update rules 310 and update file version identifiers 312-1-h may be used to implement business logic to control update operations for the computing device 110-1 by atomically applying updates to specific application programs 106-1-b in a manner that maintains version normalization. For instance, certain update operations may be applied to application x while other update operations may be applied to application y. In another example, update operations may be applied to multiple applications within a product suite, such as Microsoft Office application programs, to ensure they are all running the same versions. The file update rules 310 and update file version identifiers 312-1-h may be changed to dynamically implement business rules up to and including restricting client side product usage. The update catalogs 126, 144 may also include various pointers, such as hyperlinks, to update packages stored by the update server 140 and/or the update download server 160.

The update component 120 may initiate update operations for one or more of the application programs 106-1-b. Update operations may be initiated by the update component 120 or another system program of the computing device 110-1, such as the OS 107. Additionally or alternatively, update operations may be initiated upon request by one of the application programs 106-1-b, such as the application program 106-1 as shown in FIG. 3, for example.

Before or after initiation of update operations, the catalog module 122 may send a catalog request 302 to the update server 140 to synchronize or download a latest version of the server update catalog 144 with the client update catalog 126. The update server 140 may send a catalog response 304 with some or all of the update information stored in the server update catalog 144. The catalog manager 122 may store the update catalog 126 in the cache 108 as indicated by arrow 306. In some cases, the cache 108 may comprise a secure cache in accordance with various security policies or techniques. A set of current file version identifiers 316-1-g for various application files of the application programs 106-1-b may be compared to the update file version identifiers 312-1-h to determine whether update operations are needed, and if so, how the update operations are to be implemented by the update component 120 in accordance with the file update rules 310 and/or user commands.

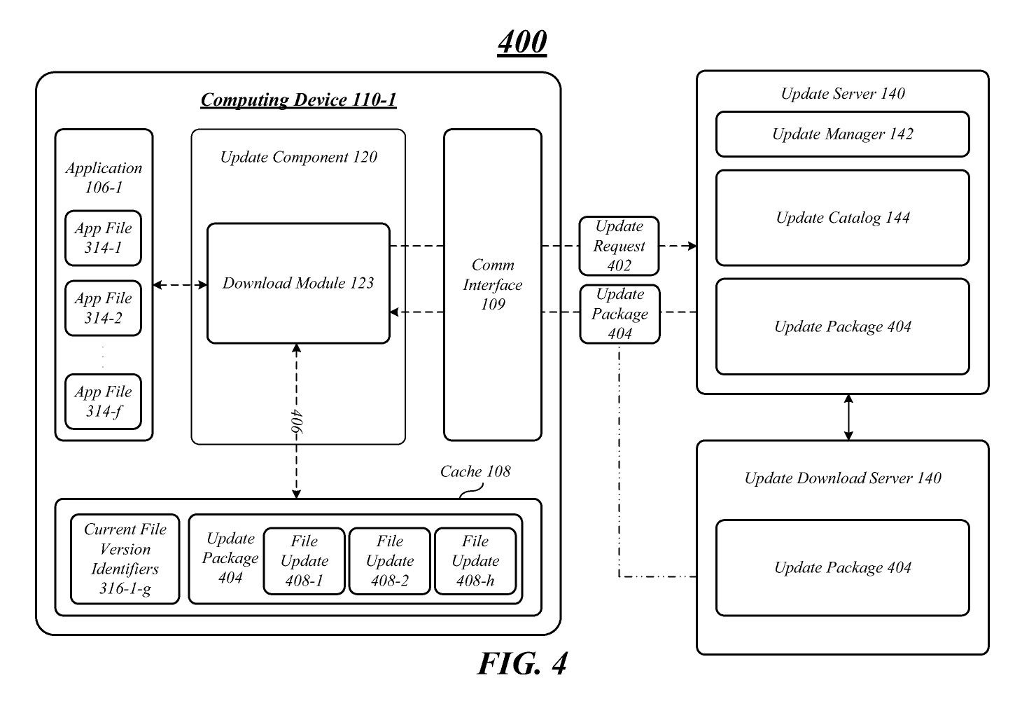

FIG. 4 illustrates an embodiment of an operating environment 400 suitable for the software update architecture 100. The operating environment 400 illustrates signaling and/or message flow between the various devices of the software update architecture 100 to provide enhanced software update services for the computing device 110-1, for example.

In the illustrated embodiment shown in FIG. 4, the update manager 121 of the update component 120 may comprise a download module 123. The download module 123 may be generally arranged to manage download operations for the update component 120. In one embodiment, the download module 123 may send an update request 402 to the update server 140 to retrieve one or more update packages 404 for the one or more application files 314-1-f of the application program 106-1 from the update server 140. For example, this may occur when one or more current file version identifiers 316-1-g for the one or more application files 314-1-f of the application program 106-1 do not match one or more update file version identifiers 312-1-h for the one or more application files 314-1-f of the application program 106-1. The update server 140 may already store the update package 404 as previously retrieved from the update download server 140, or retrieve the update package 404 from the update download server 140 in response to the update request 402. Additionally or alternatively, the download module 123 may download the update package 404 directly from the update download server 140. This may be advantageous whenever the update server 140 is offline and inaccessible, for example. Upon receiving the update package 404, the download module 123 may store the update package 404 in the cache 108, or if too large, the memory 104.

The update package 404 may include one or more file updates 408-1-h for the application programs 106-1-b. The update package may further include 404 various utilities, programs and scripts for unpacking the file updates 408-1-h and installing the file updates 408-1-h.

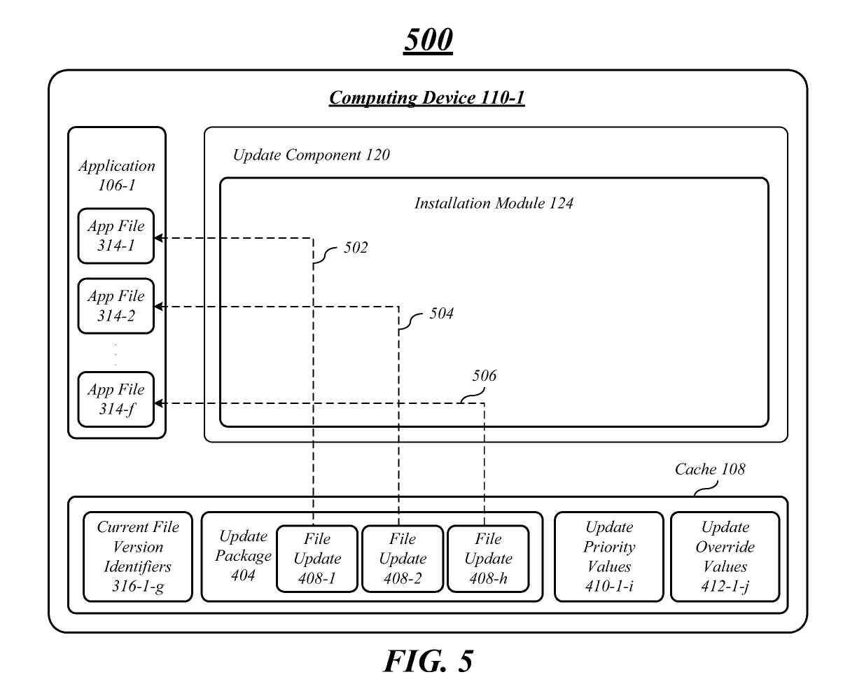

FIG. 5 illustrates an embodiment of an operating environment 500 suitable for the software update architecture 100. The operating environment 500 illustrates signaling and/or message flow between the various devices of the software update architecture 100 to provide enhanced software update services for the computing device 110-1, for example.

In the illustrated embodiment shown in FIG. 5, the update manager 121 of the update component 120 may comprise an installation module 124. The installation module 124 may be generally arranged to manage installation operations for installing file updates 408-1-h for the application programs 106-1-b. In one embodiment, the installation module 124 is operative to install each of the file updates 408-1-h corresponding to each of the application files 314-1-f of the application program 106-1 from the update package 404, as indicated by arrows 502, 504 and 506.

In various embodiments, the installation module 124 may install file updates 408-1-h for the one or more application files 314-1-f of the application program 106-1 from the update package 404 based on associated update priority values 410-1-i for the file updates 408-1-h and the file update rules 310. The update priority values 410-1-i may indicate a priority level for the file updates 408-1-h. The priority levels may include such levels as “mandatory” or “optional.” The priority levels may also indicate a time limit for installing the file updates 408-1-h, such as installing within 24 hours. Business logic to control update operations for the computing device 110-1 may be implemented, for example, by the file update rules 310 using the values stored by the update priority values 410-1-i.

In various embodiments, the installation module 124 may install the file updates 408-1-h for the one or more application files 314-1-f of the application program 106-1 from the update package 404 when an associated update priority value 410-1-i indicates a file update is mandatory. In this case, updates may automatically occur with or without notification to a user, but in any event is a forced update, and may include a forced reboot of the computing device 110-1.

In various embodiments, the installation module 124 may defer or deny installing the file updates 408-1-h for the one or more application files 314-1-f of the application program 106-1 from the update package 404 when an associated update priority value 410-1-i indicates a file update is optional. For instance, a user may be notified of the suggested update via a GUI view, and updates may be controlled based on user commands.

In various embodiments, the installation module 124 may install the file updates 408-1-h for the one or more application files 314-1-f of the application program 106-1 from the update package 404 based on associated update priority values 410-1-i for the file updates 408-1-h and associated update override values 412-1-j for the one or more application files 408-1-h of the application program 106-1. The update override values 412-1-j may be set by one of the application programs 106-1-b. One application program 106-1-b may store an update override value 412-1-j in cache 108 (e.g., via the installation module 124) for another application program 106-1-b to control update operations for the other application programs 106-1-b. For instance, the application program 106-1 may comprise part of a product suite including the application programs 106-2, 106-3. The application program 106-1 may control updates for the application programs 106-2, 106-3 to ensure there is consistent versions used across the entire product suite. To accomplish this, the application program 106-1 may set an update override values 412-2, 412-3 for the respective application programs 106-2, 106-3 to control when the application programs 106-2, 106-3 are updated. It is worthy to note that when an update override value 412-1 is not explicitly set, it may default to a null value and is not a factor in determining whether to install a particular update. In this manner, one managed application can manage updates for other managed applications.

In various embodiments, the installation module 124 may install the file updates 408-1-h for the one or more application files 314-1-f of the application program 106-1 from the update package 404 when an associated update priority value 410-1 indicates a file update is optional and an update override value 412-1 indicates a file update is mandatory. In this case, a value for the update override value 412-1 overrides a value set for the update priority value 410-1.

In various embodiments, the installation module 124 may install the file updates 408-1-h for the one or more application files 314-1-f of the application program 106-1 from the update package 404 when an associated update priority value 410-1 indicates a file update is optional and an update override value 412-1 indicates the file update is optional. In this case, a value for the update override value 412-1 matches a value set for the update priority value 410-1, and therefore one does not necessarily override the other.

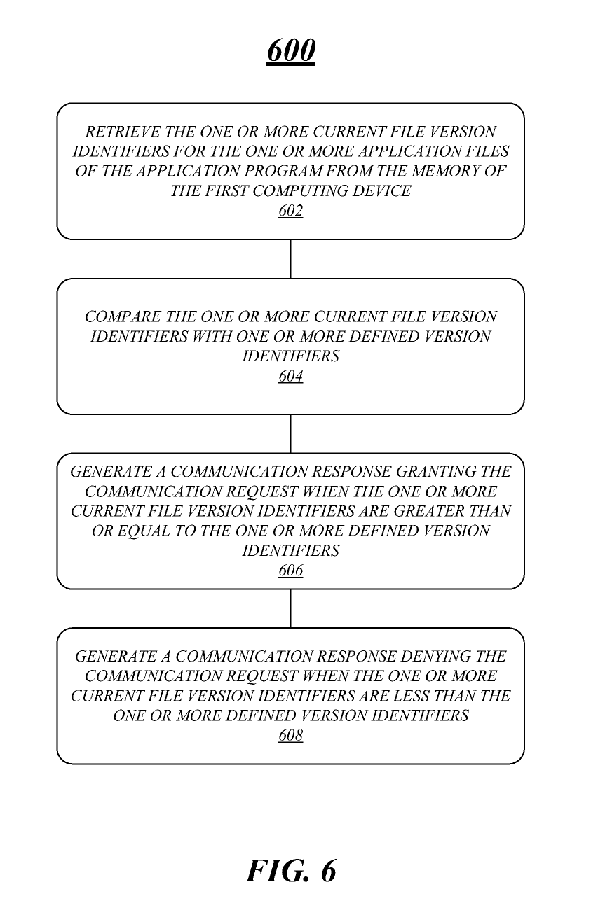

FIG. 6 illustrates one embodiment of a logic flow 600. The logic flow 600 may be representative of some or all of the operations executed by one or more embodiments described herein. For instance, the logic flow 600 may be representative of some or all of the operations executed by the computing device 110-1 and the update component 120.

In the illustrated embodiment shown in FIG. 6, the logic flow 600 may retrieve the one or more current file version identifiers for the one or more application files of the application program from the memory of the first computing device at block 602. For example, the permission manager 125 may retrieve one or more current file version identifiers 316-1-g for one or more application files 314-1-f of application programs 106-1-b from the cache 108 of the computing device 110-1.

The logic flow 600 may compare the one or more current file version identifiers with one or more defined version identifiers at block 604. For example, the permission manager 125 may compare the one or more current file version identifiers 316-1-g with one or more defined version identifiers. The defined version identifiers may represent a minimum version level suitable for the application 106-1-b for use for its intended purpose, such as communicating with an application or service implemented by another device.

The logic flow 600 may generate a communication response granting the communication request when the one or more current file version identifiers are greater than or equal to the one or more defined version identifiers at block 606. For example, the permission manager 125 may generate a communication response granting the communication request when the one or more current file version identifiers 316-1-g are greater than or equal to the one or more defined version identifiers.

The logic flow 600 may generate a communication response denying the communication request when the one or more current file version identifiers are less than the one or more defined version identifiers at block 608. For example, the permission manager 125 may generate a communication response denying the communication request when the one or more current file version identifiers 316-1-g are less than the one or more defined version identifiers.

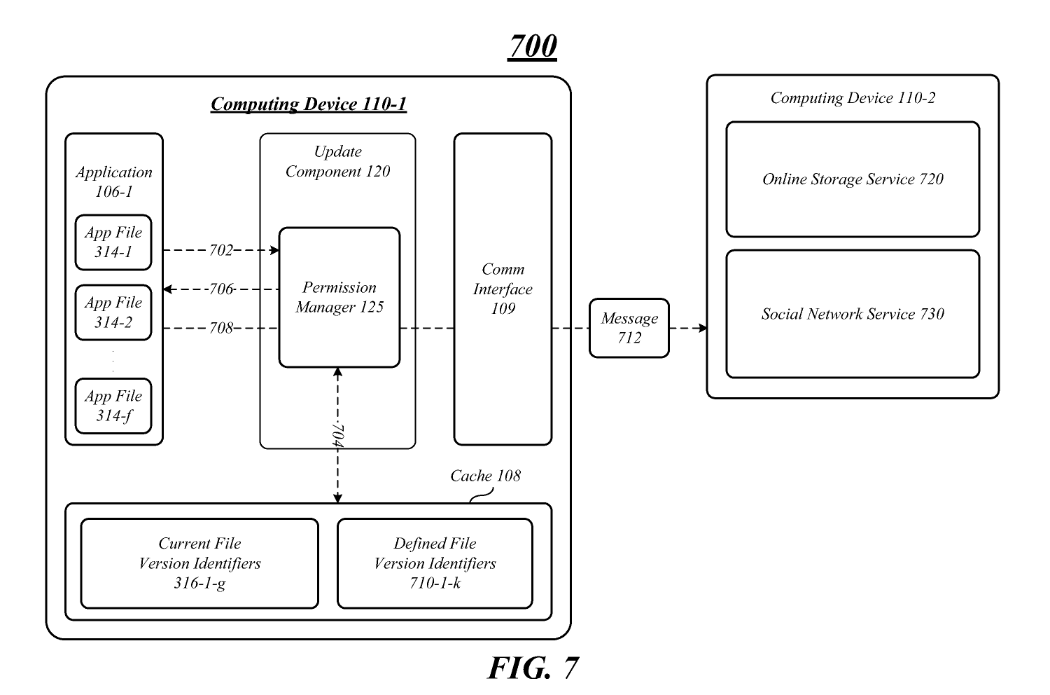

FIG. 7 illustrates an embodiment of an operating environment 700 suitable for the software update architecture 100. The operating environment 700 illustrates signaling and/or message flow between the various devices of the software update architecture 100 to provide enhanced software update and permission services for the computing device 110-1, for example.

In the illustrated embodiment shown in FIG. 7, the update component 120 may implement the permission manager 125. The permission manager 125 may be generally arranged to implement various update enforcement techniques. Prior to operation, each of the various application programs 106-1-b may communicate with the update component 120 to ensure it is using a current version for the application program 106-1-b as defined by the client update catalog 126.

In one embodiment, the application program 106-1 may send a communication request to communicate with the computing device 110-2 to the update component 120 prior to communicating information to the computing device 110-2 as indicated by arrow 702. The permission manager 125 may retrieve one or more current file version identifiers 316-1-g for the one or more application files 314-1-f of the application program 106-1 from the cache 108 as indicated by arrow 704. The permission manager 125 may compare the current file version identifiers 316-1-g with corresponding defined version identifiers 710-1-k stored in the cache 108.

The defined version identifiers 710-1-k may be used to implement various levels of permissions granted to a given application program 106-1-b. The defined version identifiers 710-1-k may represent a version level suitable for the application 106-1-b for use for its intended purpose, such as communicating with an application or service implemented by the computing device 110-2. In one embodiment, the defined version identifiers 710-1-k may match the update file version identifiers 312-1-h to ensure that only the latest versions of software applications are used when communicating with the computing device 110-2. In one embodiment, the defined version identifiers 710-1-k may match an older file version relative to the update file identifiers 312-1-h to ensure some minimum compatibility with the software applications used by the computing device 110-2. The defined version identifiers 710-1-k may be dynamically modified for each application program 106-1-b to reflect any modifications or changes to versions or permission policies implemented by the computing device 110-2. As such, the defined version identifiers 710-1-k may be directly used to control updates for the computing device 110-1 and/or access to the computing device 110-2.

The permission manager 125 may generate a communication response based on the comparison results. In one embodiment, for example, the permission manager 125 may generate a communication response granting the communication request when one or more current file version identifiers 316-1-g are greater than or equal to one or more defined version identifiers 710-1-k. In one embodiment, for example, the permission manager 125 may generate a communication response denying the communication request when the one or more current file version identifiers 316-1-g are less than the one or more defined version identifiers 710-1-k.

When granted permission, the application program 106-1 may send a message 712 to the computing device 110-2 implementing various server applications or web services, such as an online storage service 720, a social network service 730, and so forth. Other server programs may further include, for example, network application programs such as search applications, document management programs, weblogs (blogs), word processing programs, spreadsheet programs, database programs, drawing programs, document sharing programs, message applications, web services, web applications, web server, and/or other types of programs, applications, or services consistent with the described embodiments.

FIG. 8 illustrates an embodiment of an exemplary computing architecture 800 suitable for implementing various embodiments as previously described. The computing architecture 800 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors. Dual microprocessors and other multi-processor architectures may also be employed as the processing unit 804. The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures.

The system memory 806 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media, including an internal hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1384 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. The one or more application programs 832, other program modules 834, and program data 836 can include, for example, the message applications 104-1-b for the computing devices 110-1-a. When the computing architecture is implemented for the computing devices 110-1, 110-2 and/or the update server 140, the one or more application programs 832, other program modules 834, and program data 836 can include, for example, the application programs 106-1-b, update component 120, update manager 142, and so forth.

A user can enter commands and information into the computer 802 through one or more wire/wireless input devices, for example, a keyboard 838 and a pointing device, such as a mouse 840. Other input devices may include a microphone, an infra-red (IR) remote control, a joystick, a game pad, a stylus pen, touch screen, or the like. These and other input devices are often connected to the processing unit 804 through an input device interface 842 that is coupled to the system bus 808, but can be connected by other interfaces such as a parallel port, IEEE 1384 serial port, a game port, a USB port, an IR interface, and so forth.

A monitor 844 or other type of display device is also connected to the system bus 808 via an interface, such as a video adaptor 846. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
updating a file version for one or more application files of an application program for a first computing device;
storing one or more current file version identifiers for the one or more application files of the application program in a memory of the first computing device;
receiving a communication request to communicate with a second computing device from the application program prior to communicating information to the second computing device; and
sending a communication response granting or denying the communication request to the application program based on the one or more current file version identifiers.

2. The computer-implemented method of claim 1, comprising synchronizing a client update catalog with a server update catalog, with each update catalog having a set of file update rules and one or more update file version identifiers for one or more application files of one or more application programs.

3. The computer-implemented method of claim 1, comprising retrieving an update package for the one or more application files of the application program from an update server when one or more current file version identifiers for the one or more application files of the application program do not match one or more update file version identifiers for the one or more application files of the application program.

4. The computer-implemented method of claim 1, comprising installing file updates for the one or more application files of the application program from the update package based on an associated update priority values for the file updates and a set of file update rules.

5. The computer-implemented method of claim 1, comprising installing file updates for the one or more application files of the application program from the update package when an associated update priority value indicates a file update is mandatory.

6. The computer-implemented method of claim 1, comprising deferring to install file updates for the one or more application files of the application program from the update package when an associated update priority value indicates a file update is optional.

7. The computer-implemented method of claim 1, comprising storing an update override value for the application program by another application program.

8. The computer-implemented method of claim 1, comprising installing file updates for the one or more application files of the application program from the update package based on associated update priority values for the file updates and associated update override values for the one or more application files of the application program.

9. The computer-implemented method of claim 1, comprising installing file updates for the one or more application files of the application program from the update package when an associated update priority value indicates a file update is optional and an update override value indicates the file update is mandatory.

10. The computer-implemented method of claim 1, comprising deferring to install file updates for the one or more application files of the application program from the update package when an associated update priority value indicates a file update is optional and an update override value indicates the file update is optional.

11. The computer-implemented method of claim 1, comprising:
retrieving the one or more current file version identifiers for the one or more application files of the application program from the memory of the first computing device;
comparing the one or more current file version identifiers with one or more defined version identifiers;
generating a communication response granting the communication request when the one or more current file version identifiers are greater than or equal to the one or more defined version identifiers; and
generating a communication response denying the communication request when the one or more current file version identifiers are less than the one or more defined version identifiers.

12. An article comprising a storage medium containing instructions that when executed enable a system to store one or more current file version identifiers for the one or more application files of an application program in a memory unit, receive a communication request to communicate with a remote device from the application program prior to communicating information to the remote device, and send a communication response granting or denying the communication request to the application program based on the one or more current file version identifiers.

13. The article of claim 12, further comprising instructions that when executed enable the system to retrieve the one or more current file version identifiers for the one or more application files of the application program from the memory unit, and compare the one or more current file version identifiers with one or more update file version identifiers of an update catalog.

14. The article of claim 12, further comprising instructions that when executed enable the system to generate a communication response granting the communication request when the one or more current file version identifiers are greater than or equal to one or more update file version identifiers, and generate a communication response denying the communication request when the one or more current file version identifiers are less than the one or more update file version identifiers.

15. An apparatus, comprising:
a processor; and
a memory to store an update component that when executed by the processor is operative to manage updates for an application program, the update component comprising an update manager and a permission manager, the update manager operative to update a file version for one or more application files of the application program and store one or more current file version identifiers for the one or more application files of the application program in the memory, and the permission manager operative to receive a communication request to communicate with a remote device from the application program prior to communicating information to the remote device and send a communication response granting or denying the communication request to the application program based on the one or more current file version identifiers.

16. The apparatus of claim 15, the update manager comprising a catalog module that when executed by the processor is operative to synchronize a client update catalog with a server update catalog, with each update catalog having a set of file update rules and update file version identifiers for one or more application files of one or more application programs.

17. The apparatus of claim 15, the update manager comprising a download module that when executed by the processor is operative to retrieve an update package for the one or more application files of the application program from an update server when one or more current file version identifiers for the one or more application files of the application program do not match one or more update file version identifiers for the one or more application files of the application program.

18. The apparatus of claim 15, the update manager comprising an installation module that when executed by the processor is operative to install file updates for the one or more application files of the application program from the update package based on an associated update priority values for the file updates and a set of file update rules.

19. The apparatus of claim 15, the update manager comprising an installation module that when executed by the processor is operative to install file updates for the one or more application files of the application program from the update package based on associated update priority values for the file updates and associated update override values for the one or more application files of the application program.

20. The apparatus of claim 15, the permission manager operative to retrieve the one or more current file version identifiers for the one or more application files of the application program from memory, compare the one or more current file version identifiers with one or more defined version identifiers, generate a communication response granting the communication request when the one or more current file version identifiers are greater than or equal to the one or more defined version identifiers, and generate a communication response denying the communication request when the one or more current file version identifiers are less than the one or more defined version identifiers.
